(19) United States
(12) Patent Application Publication
(10) Pub. No.: US 2025/0246896 A1
(43) Pub. Date: Jul. 31, 2025

(54) INVERTER FAULT CURRENT MULTIPLIER

(71) Applicant: Georgia Tech Research Corporation, Atlanta, GA (US)

(72) Inventors: Deepak M. Divan, Marietta, GA (US); Joseph Benzaquen Sune, Atlanta, GA (US)

(21) Appl. No.: 19/040,718

(22) Filed: Jan. 29, 2025

Related U.S. Application Data
(60) Provisional application No. 63/626,280, filed on Jan. 29, 2024.

(51) Int. Cl. H02H 3/08; H02H 1/00; H02M 7/44

(52) U.S. Cl. CPC H02H 3/08; H02H 1/0007; H02M 7/44

(57) ABSTRACT

An exemplary inverter-fault-current-multiplier device and method are disclosed that can be installed into a retrofit installation of an inverter and power-generating equipment to temporarily multiply the output of the inverter so as to trip an installed circuit breaker at a home, premise, or facility. The exemplary system and method can reduce the cost of inverter and power-generating equipment installation by allowing existing circuit breakers of a home or building to be used without any modification or wiring and without the need to overrate the inverter.

### RELATED APPLICATION

This U.S. application claims priority to, and the benefit of, U.S. Provisional Patent Application No. 63/626,280, filed Jan. 29, 2024, entitled “INVERTER FAULT CURRENT MULTIPLIER,” which is incorporated by reference herein in its entirety.

### BACKGROUND

To decarbonize and decentralize the grid, homeowners and building owners are equipping their buildings/dwellings with photovoltaic panels, energy storage, or other renewable energy sources. To integrate the additional power-generating equipment into the building's electrical infrastructure, inverters are often additionally installed in the home or building.

Existing electrical infrastructure and safety codes require circuit breakers to be installed on the premises to cut power to the circuit that is drawing too much current for the circuit rating. The introduction of inverters on-premises complicates the circuit breaker circuit as existing inverters are not sized or rated to trip the circuit breakers. A straightforward but expensive solution that does not require any rewiring of the circuit breaker would be to size the inverter larger than necessary for the rating of the additional power-generating equipment to ensure that the inverter is sufficiently sized to trip the circuit breakers. An alternative would be to replace the circuit breaker with a smart circuit breaker that can sense and trip/break the circuit when working with an inverter. This later solution saves on the inverter but requires additional equipment and expensive rewiring.

There is a benefit to improving the installation of inverters and power-generating equipment infrastructure in existing homes or buildings.

### SUMMARY

An exemplary inverter-fault-current-multiplier device and method are disclosed that can be installed into a retrofit installation of an inverter and power-generating equipment to temporarily multiply the output of the inverter (e.g., by 5-10 times its rated output) so as to trip an installed circuit breaker at a home, premise, or facility. The exemplary system and method can reduce the cost of inverter and power-generating equipment installation by allowing existing circuit breakers of a home or building to be used without any modification or rewiring and without the need to overrate the inverter. Rather, the exemplary inverter-fault-current-multiplier device can be singularly mounted (as a single standalone device) and then connected between the inverter and the main input to the circuit breaker to provide the temporarily multiplied output when an over-current condition is sensed for an individual breaker that could be applied to the breaker. Indeed, the increased current provided by the exemplary inverter-fault-current-multiplier device and method can be delivered into a low-impedance fault, allowing sequential and coordinated tripping of all the downstream breakers in a home or facility, as would have occurred under grid-connected operation.

As used herein, the terms “home, premise, or facility” refer to residential, commercial, or industrial building or facilities. The current multiplier operation can be applied to single-phase circuits, biphasic circuits, three-phase circuits, and multi-phase circuits greater than 3.

As an example, for a 200 Ampere inverter feeding a 240-volt load, with a need to deliver>1000 Amperes into a fault to be able to clear all the downstream breakers, which include ratings of 15, 20, 30, 50, and 200 Amperes, the exemplary device and method can be employed as grid-connected and off-grid inverter-based resources that can be applied to residential, industrial, and utility installations up to 480 Vac and 1-3 MW. The generated multiplied current is needed to trip the breaker that is downstream of the inverter.

To minimize the size of the transformer, one embodiment of the exemplary system and method can be to use a transformer configured so the saturation current is lower than the multiplied current. As a result, during the “fault” operation mode, the transformer will be saturated to still trip the downstream breaker in a timely manner.

The exemplary device can be added to existing inverters, or can be integrated into new inverter designs and provides a temporary multiplied fault current capacity for the inverter so that it is coordinated with downstream protection switchgear. The exemplary device maintains inverter operation under normal conditions and only inserts in-circuit once a fault is detected. Once the appropriate breaker clears the fault, the inverter resumes normal operation once a breaker clears the fault. As is the case with coordinated protection, the tripped breaker also allows for pinpointing the fault while allowing the rest of the system to keep operating. The exemplary device represents a key enabler for the broad deployment of inverters, a critical component of the ongoing energy transition.

In an aspect, a device configured to couple between an inverter and a circuit breaker to facilitate tripping of the circuit breaker, the device is disclosed comprising an inverter fault current multiplier circuit comprising a transformer having a primary winding and a secondary winding, wherein the secondary winding is operatively connected with the primary winding and the circuit breaker; a first switch coupled in series with the secondary winding to magnetize the transformer when in conductive mode; a second switch configured to be in conductive mode and non-conductive mode, the second switch being connected in parallel to the primary winding to bypass the transformer when the second switch is in conductive mode and to urge current flow through the transformer when in non-conductive mode; a sensor disposed in the fault current multiplier circuit and configured to measure an inverter current, or a proportional aspect thereof, provided by the inverter to the circuit breaker; a controller operatively coupled to the first switch and the second switch, the controller being configured to receive or measure, via the sensor, the inverter current, or a proportional aspect thereof; and in response to the inverter current, or the proportional aspect thereof, meeting a fault condition for the circuit breaker, cause the first switch to switch to the conductive mode and the second switch to switch to the non-conductive mode, to allow current to flow through the primary winding and the secondary winding, thereby generating a multiplied inverter current of sufficient magnitude to the circuit breaker to trip mechanical circuit elements of the circuit breaker.

In some embodiments, the transformer is fully rated or fractionally rated.

In some embodiments, the primary winding has a higher voltage rate than the secondary winding.

In some embodiments, the primary winding has a lower voltage rate than the secondary winding.

In some embodiments, the controller is configured via instructions to cause the second switch to switch to the non-conductive mode after the controller causes the first switch to switch to the conductive mode.

In some embodiments, the generated multiplied inverter current has a magnitude corresponding to a predefined saturation current and a predefined turns ratio of the transformer.

In some embodiments, in response to the mechanical circuit elements of the circuit breaker being tripped, the controller is configured to cause the first switch to switch to the non-conductive mode and the second switch to switch to the conductive mode.

In some embodiments, the controller is integrated into the device.

In some embodiments, the controller is an external controller coupled between an inverter and a circuit breaker.

In some embodiments, the device described herein is part of a system comprising one or more power sources connected to a grid, wherein the one or more power sources are configured to power downstream loads when islanded from the grid, wherein the loads are connected via either a cascaded switchgear or a fuse configured to trip on the multiplied inverter current, and wherein the one or more power sources are a power electronics inverter configured to supply power to the grid or to power the load when the grid is not connected or available.

In some embodiments, the inverter is configured to limit current under the fault condition to at least one of (i) a value higher than a maximum sustained current it can deliver or (ii) a value that is unable to trip the breaker, as the current under the fault condition is lower than available in grid-connected mode.

In some embodiments, the first switch is a bidirectional current block switch when in the non-conductive mode and is selected from the group consisting of (i) one or more mechanical power relays and (ii) one or more semiconductor switches.

In some embodiments, the second switch is a low loss current carrying component when in the conductive mode and is selected from the group consisting of (i) one or more mechanical power relays and (ii) one or more semiconductor switches.

In another aspect, a method is disclosed comprising providing a device coupled between an inverter and a circuit breaker, the overcurrent protection having an inverter fault current multiplier circuit including a transformer, a first switch, a second switch, and a sensor; receiving or measuring, via the sensor, an inverter current, or a proportional aspect thereof, and in response to the inverter current, or the proportional aspect thereof, meeting a fault condition for the circuit breaker, causing the first switch of the device to switch to a conductive mode and the second switch to switch to a non-conductive mode, to allow current to flow through a primary winding and a secondary winding of the transformer, thereby generating a multiplied inverter current of sufficient magnitude to the circuit breaker to trip mechanical circuit elements of the circuit breaker.

In some embodiments, the second switch is switched to the non-conductive mode after the first switch is switched to the conductive mode.

In some embodiments, the generated multiplied inverter current has a magnitude corresponding to a predefined saturation current and a predefined turns ratio of the transformer.

In some embodiments, the method described herein further comprises in response to the mechanical circuit elements of the circuit breaker being tripped, switching the first switch to the non-conductive mode and the second switch to the conductive mode.

In some embodiments, the device is part of a system comprising one or more power sources connected to a grid, wherein the one or more power sources are configured to power downstream loads when islanded from the grid, wherein the loads are connected via either a cascaded switchgear or a fuse configured to trip on the multiplied inverter current, and wherein the one or more power sources are a power electronics inverter configured to supply power to the grid or to power the load when the grid is not connected or available.

In some embodiments, the inverter is configured to limit current under the fault condition to at least one of (i) a value higher than a maximum sustained current it can deliver or (ii) a value that is unable to trip the breaker, as the current under the fault condition is lower than available in grid-connected mode.

In some embodiments, the first switch is a bidirectional current block switch when in the non-conductive mode and is selected from the group consisting of (i) one or more mechanical power relays and (ii) one or more semiconductor switches.

In some embodiments, the second switch is a low loss current carrying component when in the conductive mode and is selected from the group consisting of (i) one or more mechanical power relays and (ii) one or more semiconductor switches.

In another aspect, a method of installation is disclosed comprising providing a device comprising an inverter fault current multiplier circuit comprising a transformer having a primary winding and a secondary winding, wherein the secondary winding is operatively connected with the primary winding and a circuit breaker; a first switch coupled in series with the secondary winding to magnetize the transformer when in conductive mode; a second switch configured to be in conductive mode and non-conductive mode, the second switch being connected in parallel to the primary winding to bypass the transformer when the second switch is in conductive mode and to urge current flow through the transformer when in non-conductive mode; a sensor disposed in the fault current multiplier circuit and configured to measure an inverter current, or a proportional aspect thereof, provided by the inverter to the circuit breaker; a controller operatively coupled to the first switch and the second switch, the controller being configured to receive or measure, via the sensor, the inverter current, or a proportional aspect thereof; and in response to the inverter current, or the proportional aspect thereof, meeting a fault condition for the circuit breaker, cause the first switch to switch to the conductive mode and the second switch to switch to the non-conductive mode, to allow current to flow through the primary winding and the secondary winding, thereby generating a multiplied inverter current of sufficient magnitude to the circuit breaker to trip mechanical circuit elements of the circuit breaker; mounting the device; cutting a cable between the inverter and the circuit breaker into a first cable and a second cable; terminating the first cable and the second cable at each respective end; connecting the first cable to a first terminal of the device to establish electrical connection between the primary winding of the fault current multiplier circuit and a terminal of the inverter; and connecting the second cable to a second terminal of the device to establish electrical connection between the secondary winding of the fault current multiplier circuit to a terminal of the circuit breaker.

### BRIEF DESCRIPTION OF DRAWINGS

FIG. 1 shows an example device coupled between an inverter and a circuit breaker to facilitate circuit breaker tripping. The exemplary device is configured with an inverter fault current multiplier circuit (IFCM) comprising a transformer, a first switch, a second switch, a sensor, and a controller.

FIGS. 2A-2B show example flow diagrams for operating and installing the exemplary device. FIG. 2A shows an example flow diagram for a method of operating the exemplary device. FIG. 2B shows an example flow diagram for a method of installing the exemplary device.

FIGS. 3A-3F show an example device having an inverter fault current multiplier circuit and an example residential system that employs the exemplary device. FIG. 3A shows the example inverter fault current multiplier (IFCM). FIG. 3B shows example waveforms demonstrating the multiplication of the fault current achieved by the inverter, which illustrates the operating principle of the IFCM. FIG. 3C shows a 240 V residential system in an inverter-based-resource-dominated (IBR-dominated) microgrid setting where the conventional breaker panel in a US home contains a 200 A main breaker and lower current breakers, ranging from 20-100 A, for various internal sub-circuits. FIG. 3D shows example time-current characteristics (TCC) of a 200 A breaker. FIG. 3E shows a high-level, one-line diagram of the different source configurations for the residential system. FIG. 3F shows the resulting fault current contribution from each source for a wide range of impedances (Z_{f}).

FIGS. 4A-4F shows the experimental and FEA simulation setups to evaluate the exemplary device's IFCM performance. FIG. 4A shows the schematic of the experimental setup to validate the IFCM. FIG. 4B shows the experimental results for the IFCM. FIG. 4C shows the impact of transformer parameters on the performance of the IFCM. FIG. 4D shows the impact of transformer core saturation on the IFCM's performance when the transformer turns ratio is 2 (i.e., N=2). FIG. 4E shows the equivalent schematic of the IFCM in fault mode and the three-dimensional (3D) model of the IFCM in the finite element analysis (FEA) simulation. FIG. 4F shows the FEA simulation results for the FEA model of the IFCM.

### DETAILED DESCRIPTION

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the list. For example, [1] refers to the first reference in the list. All references cited and discussed in this specification are incorporated herein by reference in their entirety and to the same extent as if each reference was individually incorporated by reference.

### Example System

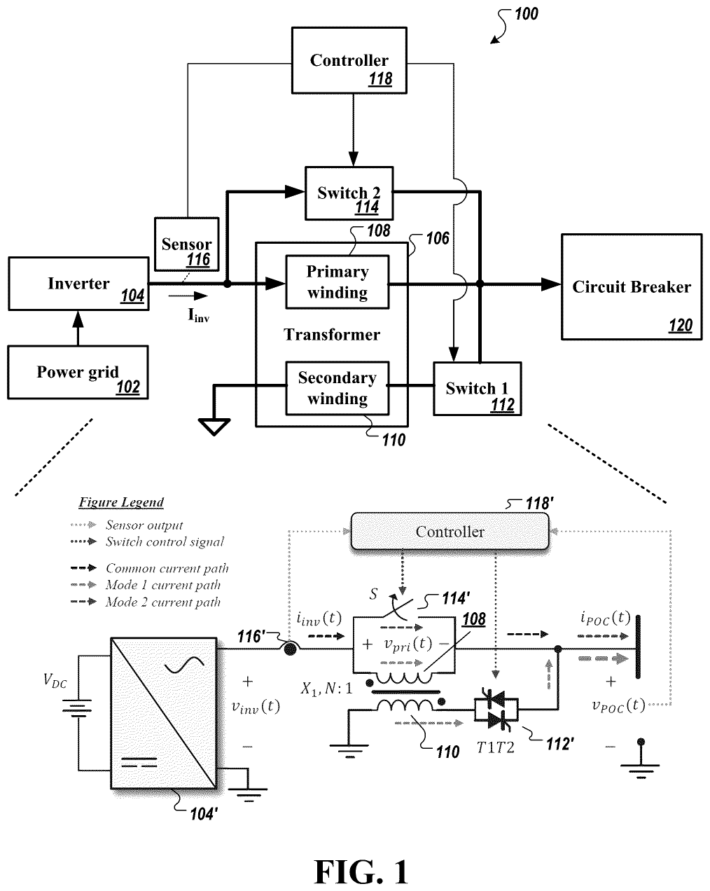

FIG. 1 shows an example device 100 coupled between an inverter 104 (shown as 104′) and a circuit breaker 120 to facilitate circuit breaker tripping. The exemplary device 100 is configured with an inverter fault current multiplier circuit 101 (IFCM) comprising a transformer 106, a first switch 112 (shown as 112′) (i.e., switch T1T2), a second switch 114 (shown as 114′) (i.e., switch S), a sensor 116 (shown as 116′), and a controller 118 (shown as 118′) (e.g., logic circuit, digital microcontroller, analog circuit).

In the example shown in FIG. 1, the inverter 104 (shown as 104′), coupled with a power grid 102, can provide the fault current multiplier circuit 101 with an inverter current (shown as Iᵢₙᵥ). The inverter 104 is configured to limit the inverter current under the fault condition to at least one of (i) a value higher (e.g., 20% to 100% higher) than a maximum sustained current it can deliver or (ii) a value that is unable to trip the breaker, as the inverter current under the fault condition is lower than available in grid-connected mode.

The sensor 116 (shown as 116′) can be disposed in the fault current multiplier circuit 101 and configured to measure the inverter current, or a proportional aspect thereof, provided by the inverter 104 to the circuit breaker 120.

The transformer 106 (shown as 106′) is configured to have a primary winding 108 and a secondary winding 110, wherein the secondary winding 110 can be operatively connected with the primary winding 108 and the circuit breaker 120. A turns ratio (denoted as N) of the transformer 106 is a ratio of the number of turns in the primary winding 108 to the number of turns in the secondary winding 110. The transformer 106 can be fully rated or fractionally rated.

In some implementations, the primary winding 108 can have a higher voltage rate than the second winding 110; the primary winding is then a high-voltage winding and the secondary winding is a low-voltage winding. In other implementations, the primary winding 108 can have a lower voltage rate than the second winding; the primary winding is then a low-voltage winding and the secondary winding is a high-voltage winding.

The first switch 112 (shown as 112′) is coupled in series with the secondary winding 110 to magnetize the transformer 106 when in conductive mode. The first switch 112 can be a bidirectional current block switch when in the non-conductive mode and can be selected from the group consisting of (i) one or more mechanical power relays and (ii) one or more semiconductor switches (e.g., thyristor, MOSFET, FET, insulated-gated bipolar transistor, and silicon-controlled rectifier).

The second switch 114 (shown as 114′) is configured to be in conductive mode and non-conductive mode. The second switch 114 can be connected in parallel to the primary winding 108 to bypass the transformer 106 when the second switch 114 is in conductive mode and to urge current flow through the transformer 106 when in non-conductive mode. The second switch 114 can be a low loss current carrying component when in the conductive mode and is selected from the group consisting of (i) one or more mechanical power relays and (ii) one or more semiconductor switches (e.g., MOSFET, insulated-gate bipolar transistor, and silicon-controlled rectifier).

The controller 118 (shown as 118′) can be operatively coupled to the first switch 112 and the second switch 114. The controller 118 is configured to receive or measure, via the sensor 116, the inverter current (shown as Iᵢₙᵥ), or a proportional aspect thereof. In response to the inverter current, or the proportional aspect thereof, meeting a fault condition for the circuit breaker 120 (e.g., exceeding a predefined saturation current), the controller 118 can cause the first switch 112 to switch to the conductive mode and the second switch 114 to switch to the non-conductive mode, to allow current to flow through the primary winding 112 and the secondary winding 114, thereby generating a multiplied inverter current of sufficient magnitude to the circuit breaker 120 to trip mechanical circuit elements of the circuit breaker. After the controller 118 causes the first switch 112 to switch to the conductive mode, the controller 118 is configured to cause the second switch 114 to switch to the non-conductive mode. In response to the mechanical circuit elements of the circuit breaker 120 being tripped, the controller 118 is configured to cause the first switch 112 to switch to the non-conductive mode and the second switch 114 to switch to the conductive mode. The controller 118 can be either (i) integrated into the exemplary device 100 or (ii) an external controller coupled between the inverter 104 and the circuit breaker 120.

The generated multiplied inverter current can have a magnitude corresponding to (and exceeding) a predefined saturation current and a predefined turns ratio of the transformer

$$( i . e . , {I}_{f} = ( N + 1 ) {I}_{inv , sat} ) .$$

The exemplary device 100 can be part of a system comprising one or more power sources (e.g., battery, PV, etc.) connected to a grid (e.g., power grid 102), wherein the one or more power sources are configured to power downstream loads when islanded from the grid, wherein the loads are connected via either a cascaded switchgear or a fuse configured to trip on the multiplied inverter current, and wherein the one or more power sources are a power electronics inverter (e.g., inverter 104) configured to supply power to the grid or to power the load when the grid is not connected or available.

### Example Methods

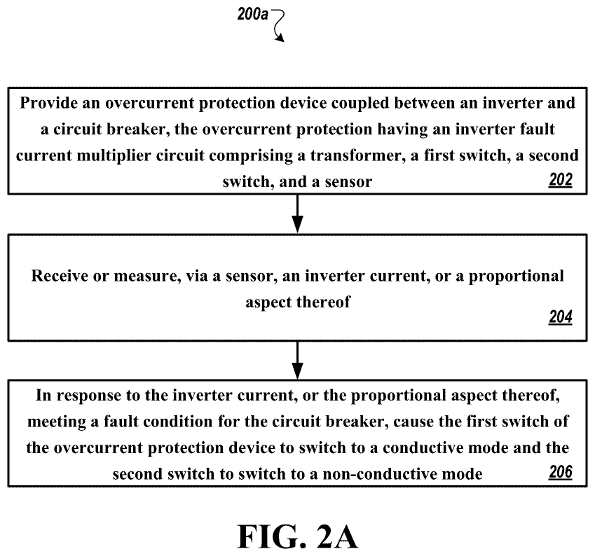

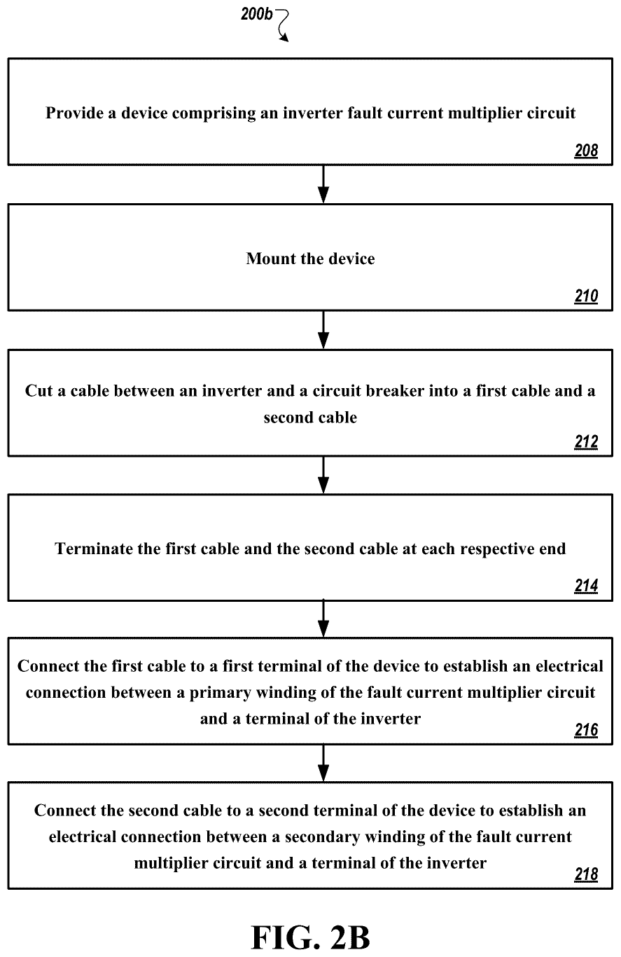

FIG. 2A shows an example flow diagram 200a for a method of operating the exemplary device, which can comprise 3 steps. As shown, at step 202, the method can provide a device coupled between an inverter and a circuit breaker. The exemplary device can have an inverter fault current multiplier circuit comprising a transformer, a first switch, a second switch, and a sensor.

At step 204, the method can receive or measure, via the sensor, an inverter current, or a proportional aspect thereof. At step 206, in response to the inverter current, or the proportional aspect thereof, meeting a fault condition for the circuit breaker, the method can cause the first switch of the exemplary device to switch to a conductive mode and the second switch to switch to a non-conductive mode.

FIG. 2B shows an example flow diagram 200b for a method of installing the exemplary device, which can comprise 6 steps. As shown, at step 208, the method can provide an exemplary device comprising an inverter fault current multiplier circuit. At step 210, the method can mount the device. At step 212, the method can cut a cable between an inverter and a circuit breaker into a first cable and a second cable. At step 214, the method can terminate the first cable and the second cable at each respective end. At step 216, the method can connect the first cable to a first terminal of the device to establish an electrical connection between a primary winding of the fault current multiplier circuit and a terminal of the inverter. At step 218, the method can connect the second cable to a second terminal of the device to establish an electrical connection between a secondary winding of the fault current multiplier circuit and a terminal of the inverter.

### Example Inverter Fault Current Multiplier (IFCM)

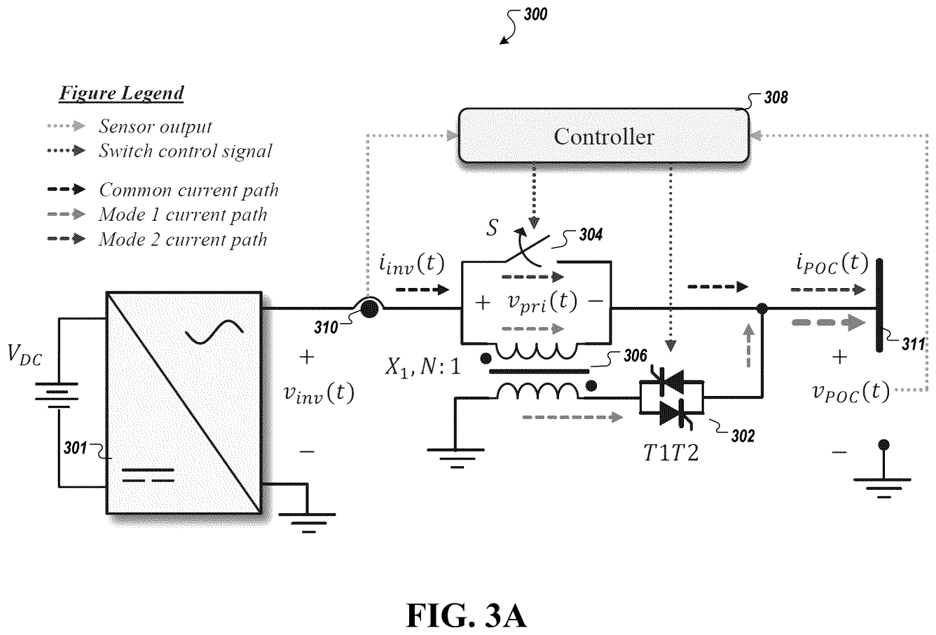

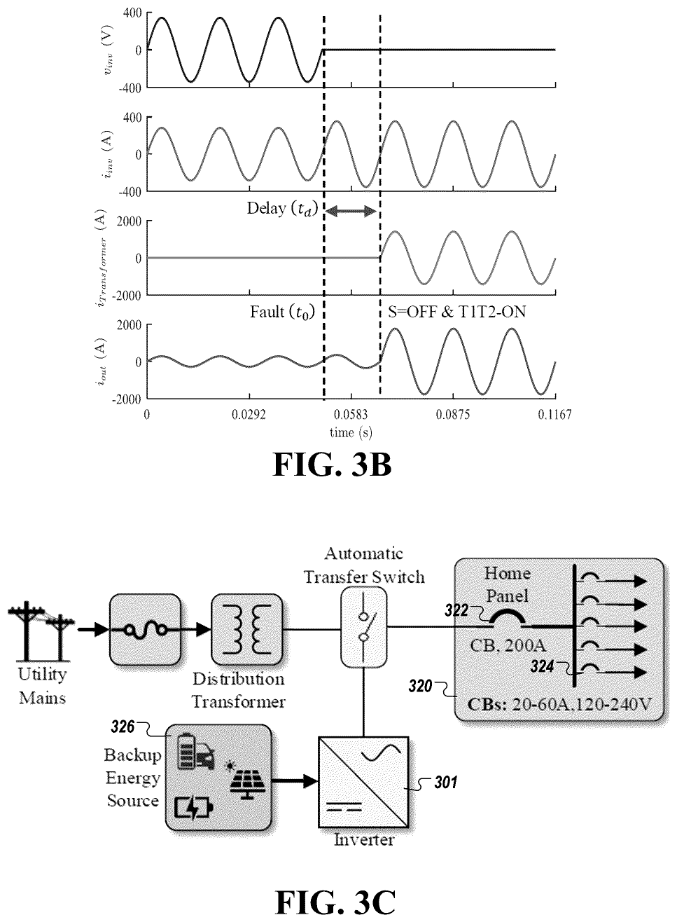

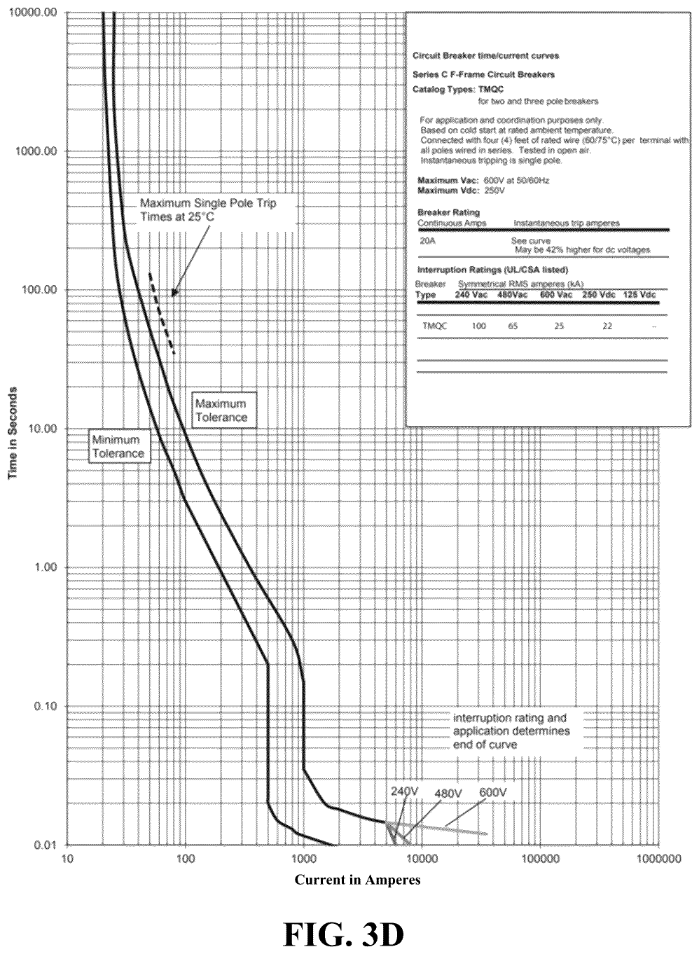

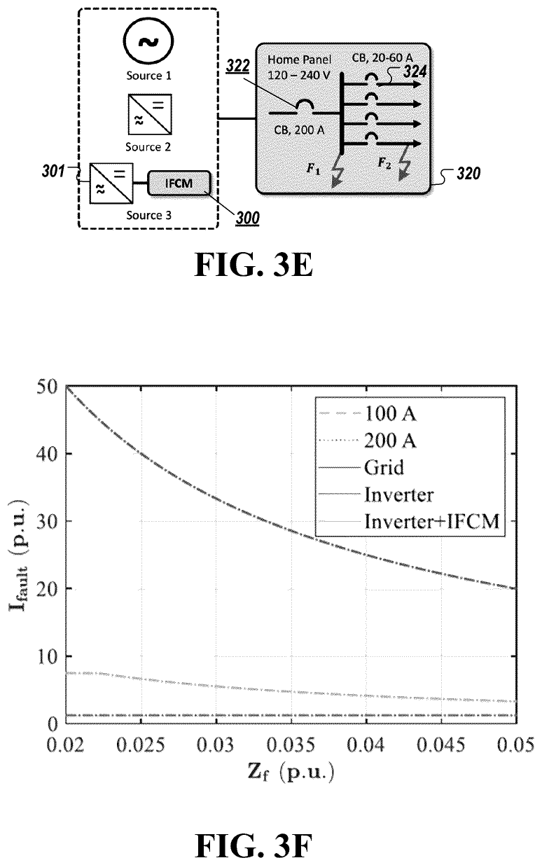

FIG. 3A shows an example device having an inverter fault current multiplier circuit 300 (shown as 101 in FIG. 1). As shown, the inverter fault current multiplier circuit 300 (IFCM) contains a combination of semiconductor switches 302 (i.e., switch T1T2) (shown as 112, 112′ in FIG. 1) and 304 (i.e., switch S) (shown as 114, 114′ in FIG. 1) and a line-frequency transformer 306 (shown as 106, 106′ in FIG. 1) that can unlock the device's core functionality. The IFCM can amplify the fault current contribution of the inverter 301 (shown as 104, 104′ in FIG. 1), where the turns ratio of the transformer 306 can control the amplification factor. The transformer 306 and switches 302 and 304 may operate only during the fault scenario for a short duration, so the design of these components can be optimized to minimize the size and cost of the IFCM. In addition, the integrated micro-controller unit 308 (MCU) (shown as 118, 118′ in FIG. 1) and sensors 310 (shown as 116, 116′ in FIG. 1) can detect the presence of faults in a defined protection zone and command the alternating current (AC) switches to trigger the IFCM.

In “normal” mode, switch S (shown as 304) is normally closed, shorting out the ‘primary’ winding of the transformer 306, and switch T1T2 (e.g., thyristors) (shown as 302) are not conducting.

During the “fault” mode, switch T1T2 (shown as 302) is gated so the thyristors start conducting. After a slight time delay, switch S is opened. At this point, the inverter current starts flowing through the “primary” winding, and N-times, this current starts circulating through the “secondary” or low-voltage winding. These two currents are added electrically at the “v_{poc}” node 311. The total current can then trip the breaker.

FIG. 3B shows example waveforms demonstrating the multiplication of the fault current achieved by the inverter, which illustrates the operating principle of the IFCM. Table 1 details the operating principle, shown in FIG. 3B, of the IFCM.

TABLE 1

| Mode of operation | Description |
|---|---|
| Mode 1 - Normal | Normal operation is the mode of operation when the |
| operation | maximum inverter current, Iᵢₙᵥ, is less than the |
| | inverter's current limit, I_{inv, sat}. |
| Mode 2 - Fault | The mode where Iᵢₙᵥ exceeds I_{inv, sat} is termed fault |
| operation | operation mode. |

In Mode “1,” the current path in steady-state conditions is shown in FIG. 3A. Relay S (shown as 302) is gated on, and T1T2 (shown as 304) is gated off, so the inverter can provide the power demand. Moreover, relay S may be rated for continuous current conduction, which is 200 A in the study (e.g., 200 A in a residential system). Since S is normally on, the primary winding (high-voltage, low-current) of the transformer 306, X1, may be shorted, and the transformer may not be magnetized in a steady state. As a result, X1 may operate at line frequency for a short duration in Mode 2, and its design can be optimized to realize a minimally sized solution.

The integrated sensors 310 and MCU 308 may determine the appropriate operating mode of the IFCMsystem 300. An intelligent, adaptive protection algorithm can also be deployed on the MCU 308 to provide reliable overcurrent protection (OCP) for inverter-based-resource-rich (IBR-rich) grids in various scenarios, including high and low-impedance faults.

In Mode “2,” The current path in this mode is also shown in FIG. 3A. Once the micro-controller unit 308 (MCU) detects an OCP fault based on inputs from the integrated sensors 310, switch S (shown as 302) may be gated off while T1T2 (shown as 304) may be gated on. The fault may also trigger the inherent current-limiting scheme of the inverter 301 that limits the maximum inverter current, Iinv, at Iinv,sat. Based on the switch configuration of the IFCM 300 in this mode, the inverter current may magnetize the transformer 306, and the resulting fault current, I_{f}, can be defined per Equation 1, increasing the fault current by a factor of N+1.

$${I}_{f} = ( N + 1 ) {I}_{inv , sat} \qquad ( Eq . 1 )$$

The transformer turns ratio N is selected so that the amplified fault current can trip a main breaker (e.g., 200 A breaker) (shown as 320 in FIG. 3C) within a specified trip duration, as dictated by the overarching power system guidelines. The resulting voltage applied across the high-voltage winding of the transformer may be defined per Equation 2.

$${V}_{p r i} = ( N {I}_{f} {Z}_{f} ) + {I}_{inv , sat} ω {L}_{lk} \qquad ( Eq . 2 )$$

In Equation 2, Lₗₖ and ω_{L} are the total leakage inductance reflected to the high-voltage winding (Lₗₖ=L₁+N²L₂) and line frequency, respectively. FIG. 3D shows that a high leakage inductance can increase the effective voltage applied across the transformer, increasing the size of its core to avoid saturation.

Given the switching stress that switches S and T1T2 experience, selecting an appropriate switching device for these components may be important. In an embodiment, for a 120 V, 2 IFCM with a 1.25 p.u. current-limited inverter in a residential system, the voltage and current ratings for switch S can be 250 V and 375 A, respectively, with a safety factor of 50% for a conservative design [16]. Both switches should also be capable of bidirectional operation. Table 2 summarizes key specifications for 4 dominant switch technologies: IGBTs, MOSFETs, SCRs, and power relays. To illustrate a preliminary cost comparison of devices at a high level, the devices are selected based on the lowest-cost components that satisfy the minimum specifications for a residential system. This criterion resulted in potentially overrated components, but the data presented in Table 2 still highlights the relative cost of different electronic switch technologies for the IFCM application.

TABLE 2

| | | | |
|---|---|---|---|
| Switch type, model | V_{sw} (V) | I_{sw} (A) | Price |

For switch S

| | | | |
|---|---|---|---|
| IGBT, IXXK200N | 600 | 380 | $15 |
| SCR, T390N | 1600 | 600 | $97 |
| MOSFET, | 1200 | 435 | $259 |
| NXH003P120M | | | |
| Power relay, 3RT2036 | 440 | 300 | $84 |

For switch T1T2

| | | | |
|---|---|---|---|
| IGBT, FZ600R17K | 1200 | 900 | $131 |
| SCR, N0795YN140 | 1400 | 1580 | $60 |
| MOSFET, | 700 | 1021 | $850 |
| MSCSM70DUM017AG | | | |

In Table 2, discrete IGBTs in reverse blocking configuration may be an ideal choice for a low-cost solution for switch S. Thyristor and MOSFET modules may be an alternative option, but these technologies are more expensive and may further increase the overall solution cost [17]. Electromechanical contactors, or power relays, may be an option with a simpler control architecture but are more expensive than IGBTs with limited current ratings for AC applications. In addition, the contactors may have lower switching speeds, which may not be fast enough for the IFCM application.

For T1T2, the switching devices experience high current stress only until the breaker trips. Therefore, its current rating is dictated by the resulting i²t specification, whereas the voltage rating is governed by the peak system voltage in steady-state. From Table 2, thyristor modules are a mature class of devices that can meet these specifications at a lower cost than other semiconductor device technologies, such as IGBTs and MOSFETs [18].

Residential IFCM System. The IFCM can be used in a residential system. FIG. 3C shows a 240 V residential system in an IBR-dominated microgrid setting where the conventional breaker panel 320 in a US home contains a 200 A main breaker 322 and lower current breakers 324, ranging from 20-100 A, for various internal sub-circuits [12], [13]. When the residential microgrid is grid-connected through the automatic transfer switch, sufficient fault contribution from the grid can trip the appropriate breakers for a downstream fault while meeting the protection zone coordination goals of this system. However, when islanded, the fault current limit of inverters is in the range of 1.2-1.5 p.u. [14]. This current limit translates to a maximum fault current magnitude of 240-300 A for the residential system, assuming that the inverter 301 is rated at 200 A for providing whole-home backup.

FIG. 3D shows example time-current characteristics (TCC) of a 200 A breaker. Based on the TCC of typical 200 A breakers as shown, this fault current contribution is sufficient to trip the lower current-rated breakers (e.g., 324 in FIG. 3C) but not the main 200 A breaker (e.g., 320 in FIG. 3C).

In addition, realistic inverter ratings can be lower than 200 A, which further reduces the fault current magnitude, exacerbating the inability to trip the 200 A main breaker. As a result, existing commercial solutions (e.g., 326 in FIG. 3C) have been used to address this problem by providing the necessary smart panels and breakers to controllably trip protection devices. However, installing such ‘smart-panel’ solutions can be expensive and may result in a financially infeasible solution for customers who upgrade their home infrastructure [11].

A solution to this problem may be to replace the traditional electromagnetic breakers in the home panel with solid-state or other electronically controlled solutions. However, this system modification entails an expensive, resource-intensive process [11]. In contrast, the Inverter Fault Current Multiplier circuit (IFCM) can provide a solution that can amplify the fault current contribution from an inverter to achieve the OCP goals of an IBR-rich grid system.

In FIG. 3A, the IFCM can combine AC switches (e.g., 302, 304) with a transformer 306 to amplify the fault current contribution of an inverter 301. The IFCM can treat the inverter 301 as a black box and can be deployed independently of an inverter 301 or within a new inverter's design. This modularity of the IFCM's design is enabled by integrated sensors 310 and an MCU 308 that monitors the residential system's electrical parameters to determine the appropriate operating mode for the IFCM. Thus, the IFCM can clear both low and high-impedance faults despite the fault injection limitations of inverters.

Impact of IFCM on the residential system. In the residential system, the nominal system voltage (V_{base}) is 240 V, and the inverter's current limit is set at 1.25 p.u. Two cases of a 100 A and 200 A rated inverter are considered for each scenario, which defines the base resistance. Three scenarios are considered to detail the effect of the IFCM on a low-voltage residential system's protection regime. In scenario 1, the residential system is grid-connected, so the source of fault current for any downstream fault is the bulk grid. In this scenario, I_{f} can be defined per Equation 3.

$${I}_{f} = \frac{{V}_{b a s e}}{{R}_{f}} \qquad ( Eq . 3 )$$

In scenario 2, an islanded system is emulated where the source of the fault current is only an inverter. In this scenario, I_{f} can be defined per Equation 4.

$${I}_{f} = \frac{{V}_{b a s e}}{{R}_{f}} , where {I}_{f}^{max} = {I}_{inv , sat} \qquad ( Eq . 4 )$$

Finally, scenario 3 is the same as scenario 2, but the IFCM can be installed at the terminals of the inverter where I_{f} can be defined per Equation 5.

$${I}_{f} = \frac{{V}_{b a s e}}{{R}_{f}} , where {I}_{f}^{max} = ( N + 1 ) {I}_{i n v , s a t} \qquad ( Eq . 5 )$$

FIG. 3E shows a high-level, one-line diagram of the different source configurations for the residential system. FIG. 3F shows the resulting fault current contribution from each source for a wide range of Z_{f}. Furthermore, Table 3 shows the resulting fault current magnitudes achieved by each source configuration at the minimum Z_{f} of 2%.

TABLE 3

| Source type | \|\|I_{f}\|\| (p.u) | Breaker tₒₚₑₙ | |
|---|---|---|---|
| 100 A Inverter | 1.25 | >1000 | s |
| 200 A Inverter | 1.25 | >1000 | s |
| 100 A Inverter + IFCM | 7.5 | 6 | s |
| 200 A Inverter + IFCM | 7.5 | 2 | s |

In Table 3, the IFCM increases the fault contribution as compared to the scenario where only the inverter is present in the residential system (e.g., scenarios 2-3). If the residential system is grid-connected (e.g., scenario 1), the 200 A breaker trips instantly. However, with only the inverter in an islanded system configuration, the 200 A breaker does not trip for any downstream fault. In addition, if a lower-rated inverter is installed in the system, the overall fault current from the inverter is further reduced and may not be sufficient to trip the lower current-rated breakers as well. Finally, if the IFCM is deployed at the terminals of the inverter (e.g., scenario 3), the multiplication of the fault current ensures that the appropriate circuit breaker, either the 200 A main or smaller breakers, is tripped in a deterministic time that may be tolerable by the residential system's OCP requirements.

### EXPERIMENTAL RESULTS AND ADDITIONAL EXAMPLES

A study was conducted to develop and evaluate the hardware configurations and performances of the exemplary device having an inverter fault current multiplier circuit (IFCM). The study also validated the effect of electrical parameters (e.g., resistance, voltage, current, etc.) on the IFCM and developed optimization methods for the transformer of the IFCM to improve the overall design and performance of the exemplary device.

### Hardware Validation for IFCM

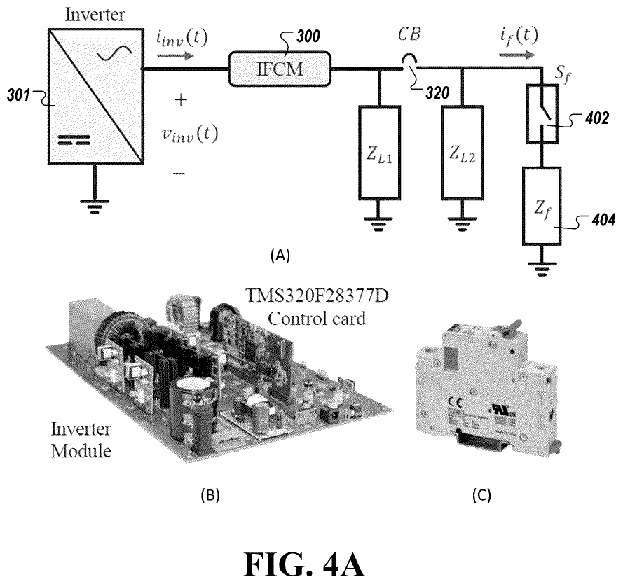

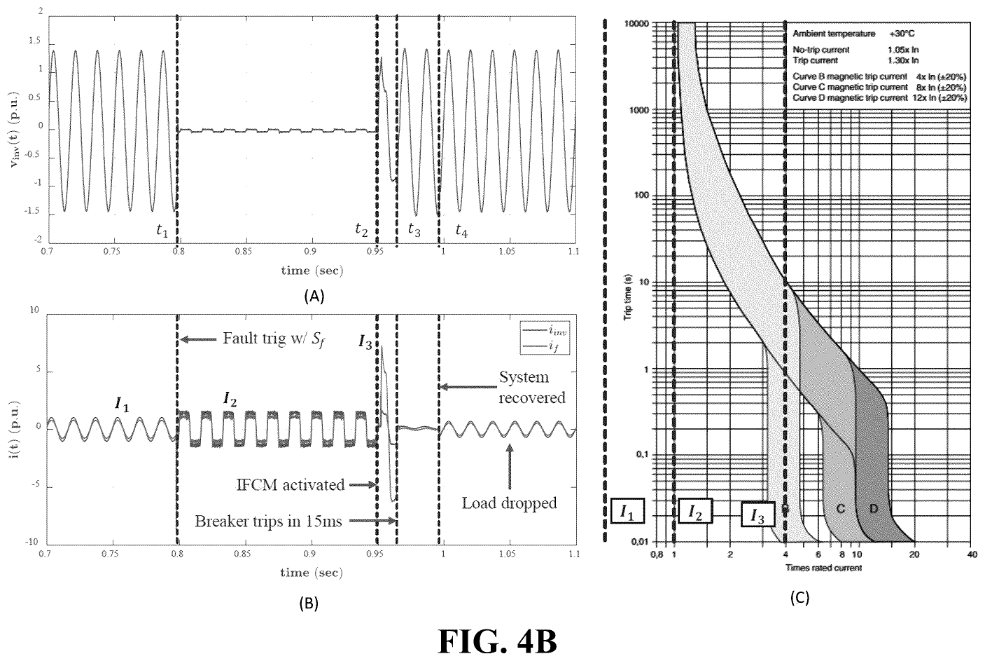

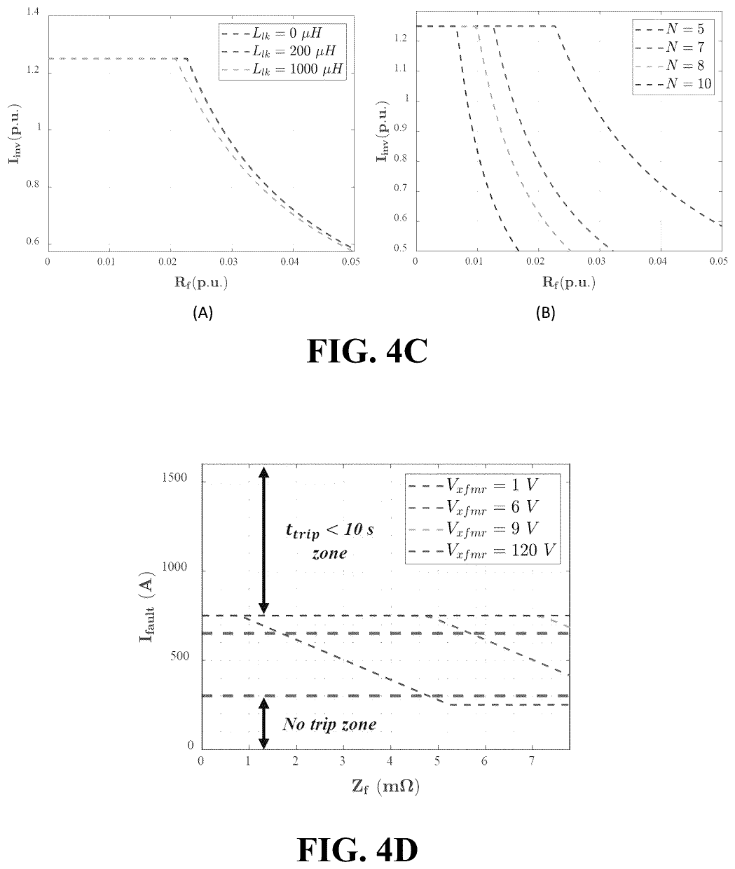

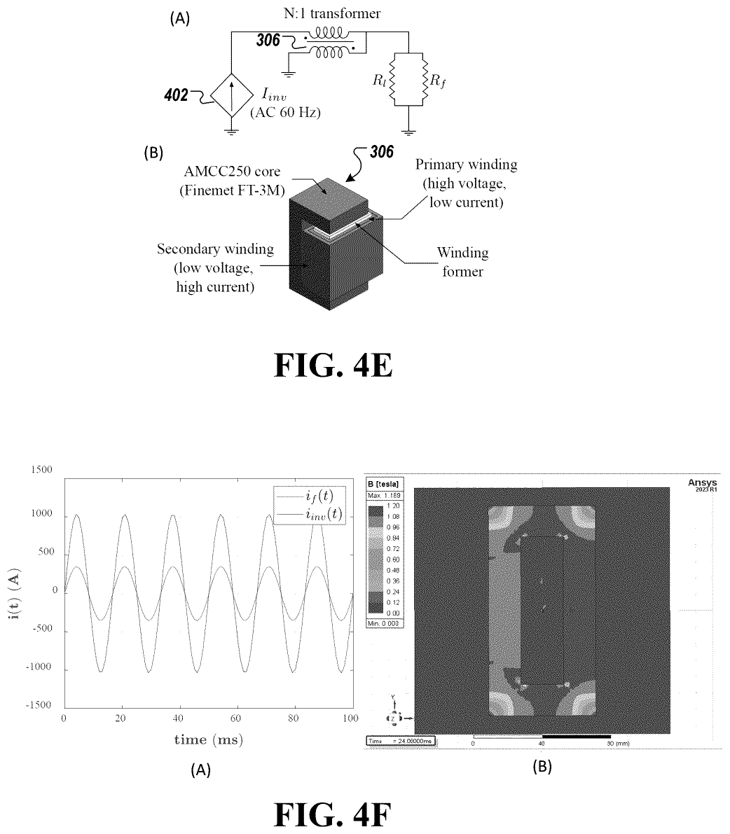

FIG. 4A shows the schematic of the experimental setup to validate the IFCM. As shown, the study used a single-phase 600 W inverter from Texas Instruments as an inverter source 301 for the experiments [19]. For limiting the currents during overcurrent scenarios, the study used a hard current-limiting method that changes the inverter current switching [20]. This methodology was selected because it was implemented on the PWM layer and yielded a fast fault response [20]. Though other current limiting mechanisms may be chosen [3], the performance of IFCM was similar. In addition, a mechanical switch 402, S_{f}, triggered a low-impedance fault scenario with the equivalent impedance Z_{f} (shown as 404). Finally, a breaker 320 (shown as CB) was selected based on the nominal testing conditions.

In the setup shown in FIG. 4A, for the IFCM prototype (shown as IFCM 300), electromechanical relays were used as switches S and T1T2 to simplify the switch implementation [21]. For the transformer of IFCM 300, a silicon steel core was used to leverage its higher saturation flux density rating to minimize the core size. Although silicon steel resulted in higher core losses in steady-state, the IFCM transformer operated at low frequency (50 or 60 Hz) for a short duration, mitigating this concern [22]. Table 4 outlines the specifications of the IFCM and transformer in the experiment.

TABLE 4

| Parameter | Symbol | Value | |
|---|---|---|---|
| Inverter base voltage | Vᵢₙᵥ | 50 | V |
| Inverter base current | Iᵢₙᵥ | 2 | A |
| Inverter current limit | I_{inv, sat} | 2.6 A (1.3 p.u.) | |
| Circuit breaker rated current | I_{GB}^{rated} | 2 | A |
| Transformer turns ratio | N | 5 | |
| Transformer Core material | | Silicon-steel (Bₘₐₓ = 1.5 T) | |
| Transformer Cross-section area | A_{eff} | 8.5 | in² |

FIG. 4B shows the experimental results for the IFCM. Subpanel (a) shows the inverter terminal voltage, whereas subpanel (b) shows the inverter current, iᵢₙᵥ, and fault current, i_{f}, responses. Initially, the IFCM operated in a steady state (Mode 1), and the inverter provided the required load power. At t₁, a low-impedance fault was triggered using S_{f}, which collapsed the inverter's terminal voltage as it entered its current-limiting mode of operation. The resulting inverter and fault currents were limited to a maximum value of 1.3 p.u. From the breaker's TCC in subpanel (c), this fault current was insufficient to trip the breaker CB (shown as 320 in FIG. 4A) to clear the fault.

After a short delay, the IFCM was activated at t₂ and increased the fault current by six due to the exemplary device's pre-configured N+1 amplification factor. Due to the increased fault current, the series breaker, CB, tripped at t₃ according to its TCC. Finally, at t₄, the system recovered after the load downstream of CB was dropped, clearing the faulted part of the experimental network. As a result, this scenario validated that the exemplary device can achieve the necessary fault current amplification to clear faults in the inverter's corresponding protection zone.

The transformer used in this experiment was developed based on a steady-state system voltage at 120 V. Furthermore, the conductors for the transformer windings were overrated to prevent the wires from overheating. However, this methodology resulted in a large transformer size, as shown in Table 4, which was expensive and can have a large impact on the modularity of the exemplar system.

### Transformer Minimization for the IFCM

The main performance metric for the IFCM was the maximum fault current it can provide for various scenarios, ranging from short-circuit faults to high-impedance faults. The previous IBR-rich residential system, shown in FIG. 3C, with a grid-forming inverter, was considered to assess the impact of the transformer's turns ratio (N) and total leakage inductance (Llk) on the IFCM's performance. Since the X/R ratio of distribution systems was low, the system was assumed to be resistive for this study [23]. Moreover, a grid-forming inverter, using traditional current limiting algorithms, may operate as a voltage source in a steady state and a current source during an overcurrent fault due to its inherent current-limiting control [20]. Finally, the maximum fault resistance (R_{f,max}) for a fault on the 200 A bus was dominated by the resistance of a 200 A cable, which was an American Wire Gauge (AWG) 2/0 size conductor with a maximum length of 100 ft in residential environments [24]. This resulted in an R_{f,max} of 8 mΩ. Table 5 shows the final system specifications used for this study.

TABLE 5

| Parameter | Symbol | Value | |
|---|---|---|---|
| Inverter base voltage | Vᵢₙᵥ | 120 | V |
| Inverter base current | Iᵢₙᵥ | 200 | A |
| Inverter current limit | I_{inv, sat} | 250 A (1.25 p.u.) | |
| Load resistance | R_{L} | 0.6 | Ω |
| Maximum fault resistance | R_{f, max} | 8 | mΩ |

Effect of transformer parameters on the performance of the IFCM. Based on this system description and fundamental circuit analysis of the IFCM, the fault current magnitude can be defined per Equation 6.

$${I}_{f} = ( N + 1 ) ‖ {I}_{i n v} ‖ \qquad ( Eq . 6 )$$

In Equation 6, ∥Iᵢₙᵥ∥ is the magnitude of the inverter terminal current, wherein ∥Iᵢₙᵥ∥ can be defined per Equation 7 when the inverter operates as a current source, and ∥Iᵢₙᵥ∥ can be defined per Equation 8 when the inverter operates as a voltage source.

$$‖ {I}_{i n v} ‖ = {I}_{inv , sat} \qquad ( Eq . 7 )$$

$$‖ {I}_{i n v} ‖ = \frac{{V}_{i n v} ( {R}_{f} + {R}_{L} )}{\sqrt{{( {R}_{L} {R}_{f} ( N + 1 ) )}^{2} + {( ω {L}_{l k} ( {R}_{L} + {R}_{f} ) )}^{2}}} \qquad ( Eq . 8 )$$

In Equations 7 and 8, Vᵢₙᵥ is the terminal voltage of the inverter, R_{L} is the base resistance of the system, Iinv, sat is the pre-configured current limit of the inverter, and R_{f} is the fault resistance approximated to be the total line impedance seen by the inverter.

FIG. 4C shows the impact of transformer parameters on the performance of the IFCM. As shown, parametric sweeps of this analytical model for R_{f} ranging from 0.2% to 5% of R_{base} illustrate the impact of N and Lₗₖ on the magnitude of Is provided by the IFCM.

From Equations 6-8, the IFCM delivered the maximum fault current when the inverter operated in current-limiting mode. However, in subpanels (a) and (b), as R_{f}, Lₗₖ, and N increased, ∥Iᵢₙᵥ∥, I_{f} decreased beyond a critical value of R_{f}. This effect was due to the increase in Vᵢₙᵥ, dictated by FIG. 3D, representing a high-impedance fault scenario. Herein, the inverter's controller operated the power converters as a voltage source. In addition, subpanel (a) also shows that as Lₗₖ reduced below 200 μH, its impact on the exemplary device's fault current contribution was minimized. This resulted in the first design objective for the transformer of the IFCM: to minimize N and Lₗₖ while achieving the OCP goal.

Another dimension to consider for the transformer's design was the core area (A_{eff}), which can be defined per Equation 9.

$${A}_{eff} = \frac{{V}_{p r i}}{{K}_{f} {B}_{max} {n}_{1} f} \qquad ( Eq . 9 )$$

In Equation 9, Vₚᵣᵢ and n₁ are the transformer's primary (high-voltage) winding voltage and turns, respectively. Bₘₐₓ was approximately 1.5 T for silicon steel cores, f was 60 Hz, and K_{f} was 4.44, assuming sinusoidal excitation of the transformer core. From FIG. 4C, minimizing the rated voltage of the transformer (V_{xfmr}) can reduce the required A_{eff} by allowing the core to saturate. However, a tradeoff emerged. As the core saturated, its magnetizing current (iₘ) increased and reduced the exemplary device's I_{f} that can be now defined per Equation 10.

$${I}_{f} = \frac{( N + 1 )}{{R}_{L} + {R}_{f}} \sqrt{{I}_{i n v}^{2} - {( \frac{N ‖ {I}_{m} ‖}{N + 1} )}^{2}} \qquad ( Eq . 10 )$$

In Equation 10, ∥Iᵢₙᵥ∥ can be defined per Equations 7-8, and ∥Iₘ∥ can be defined per Equation 11 [25].

$$‖ {I}_{m} ‖ = \frac{\sqrt{{( {λ}_{s} - {λ}_{k} )}^{2} + 8 D {L}_{l k}} + {λ}_{s} - {λ}_{k}}{4 {L}_{l k}} - \frac{D}{{λ}_{k}} \qquad ( Eq . 11 )$$

In Equation 11, λₘ, λₖ, λₛ, D, A, B, and C are defined in [25].

To analyze the core saturation tradeoff, FIG. 4D shows I_{f} for R_{f}, ranging from 0.1% to 100% of R_{f,max}, and V_{xfmr} if N=2. As shown, a V_{xfmr} of 9 V still achieved the main goal of the IFCM to trip the 200 A main breaker within 10 sec, representing a 92% reduction of V_{xfmr}. Therefore, the transformer size can be further reduced by allowing its core to saturate without compromising the performance of the IFCM.

Finally, the required window area of the transformer was constrained by the winding cross-section area (A_{win}). This constraint was primarily defined by the desired thermal performance to limit the rise in temperature of the conductors. To minimize the transformer size, A_{win} was designed based on the desired temperature rise specification since the windings were subjected to current stress for a short time period of less than 10 sec. As a result, assuming no cooling of the windings for a conservative design, A_{win} can be specified per Equation 12.

$${A}_{win} = \sqrt{\frac{{I}_{win}^{2} r Δ t}{ρ {c}_{p} Δ T}} \qquad ( Eq . 12 )$$

In Equation 12, I_{win} is the root mean square (RMS) winding current, Δt is the conduction time period, and ΔT is the maximum allowable temperature rise. ρ, cₚ, and r are the winding conductor material's density, specific heat, and resistivity.

Final transformer design validation. Based on the optimization process outlined in the preceding section, the final design of the minimum feasible transformer for a 120 V, 200 A IFCM was summarized in the study with the following assumptions: (i) 200 A main breaker tₒₚₑₙ<10 sec, (ii) Copper conductor properties: ρ=8960 kg/m³, cₚ=385 J/(kg·K), r=1.77×10−8Ω, and (iii) Maximum allowable conductor temperature rise (ΔT)=200° C. due to negligible cooling.

In the study, a lower N maximized the IFCM's fault current contribution. However, the minimum constraint on the turns ratio was set by the needed current amplification factor to trip the 200 A main breaker within 10 seconds. Therefore, based on the above assumptions and the main breaker's TCC (shown in FIG. 3C), the transformer N for this application can be defined per Equation Set 13 and the winding cross-section areas from Equation 12 were 4.3 mm² and 9.0 mm² for Aₚᵣᵢ, A_{sec} respectively, since Iₚᵣᵢ=I_{inv, sat}=250 A and I_{sec}=N×Iₚᵣᵢ=500 A.

$$\begin{matrix}{I}_{f}^{*} = 750 A ; {I}_{inv , sat} = 250 A \\ \frac{{I}_{f}}{{I}_{i nv , sat}} = N + 1 = 3 \to N = 2\end{matrix} \qquad ( Eq . Set 13 )$$

To design the transformer core geometry, the study used the area product (Aₚ) formulation to identify the optimum window area (WA) and effective core cross-section area (A_{eff}). The study selected Hitachi Finemet-FT3M as the core material to leverage its high Bₘₐₓ rating of 1.23 T [26]. Assuming a sinusoidal excitation of the transformer by the inverter in the fault mode, the Aₚ for the application described was 206.46 cm⁴, defined per Equation 14.

$${A}_{p} = ( {A}_{p r i} + \frac{1}{N} {A}_{s e c} ) \times ( \frac{{V}_{x f m r}}{{K}_{f} {B}_{max} f {k}_{c u}} ) \qquad ( Eq . 14 )$$

In Equation 14, K_{f}=4.44, N=2, f=60 Hz, V_{xfmr}=9 V, and the fill factor (k_{cu}) is 0.3 for a conservative window area design to account for the space occupied by the winding former and conductor insulation. The closest commercially available core size that can meet the Aₚ specification is the AMCC-250 Finemet-FT3M core (A_{eff}=9.35 cm², WA=22.5 cm², Iₘ=30.60 cm, Bₘₐₓ=1.27), which was used to realize the minimized the transformer design of the IFCM. As a result, the primary and secondary winding turns were 31 turns and 16 turns, respectively, as defined per Equation 15.

$${n}_{1} = \frac{{V}_{x f m r}}{{K}_{f} {B}_{max} f {A}_{eff}} \to {n}_{2} = \frac{{n}_{1}}{N} \qquad ( Eq . 15 )$$

Table 6 summarizes the specifications of the final transformer in the IFCM.

TABLE 6

| Parameter | Quantity | Value | |
|---|---|---|---|
| Transformer voltage | V_{xfmr} | 9 | V |
| Turns ratio | N | 2 | |
| Transformer cross-section area | A_{eff} | 9.35 | cm² |
| Transformer window area | WA | 22.50 | cm² |
| | lₘ | 30.60 | cm |
| Primary turns | n₁ | 31 | turns |
| Secondary turns | n₂ | 16 | turns |
| Field strength | _{Bmax} | 1.2 | T |

The study performed a transient finite element analysis (FEA) in the ANSYS Maxwell environment to validate the transformer design. The equivalent model of the IFCM in the fault mode (Mode 2) was emulated using an external circuit in ANSYS to excite the transformer appropriately. FIG. 4E shows the equivalent schematic in fault mode (subpanel a) and the three-dimensional (3D) model (subpanel b) of the IFCM in the FEA simulation.

A grid-forming (GFM) inverter (shown as 301 in FIG. 3A) operated in a current-limiting mode in the event of a fault, so it was modeled as a current source 402 in subpanel (a). Moreover, to emulate a high-impedance fault scenario that can potentially limit the IFCM's performance, the maximum expected fault resistance (R_{f,max}=8 mΩ) was used to test the IFCM.

FIG. 4F shows the FEA simulation results for the FEA model of the IFCM. Subpanel (a) shows the fault current (i_{f}(t)) and inverter terminal current (iᵢₙᵥ(t)) where I_{f} and ∥Iᵢₙᵥ∥ were 731 A and 248 A, respectively, resulting in a fault amplification factor of 3 as expected by the fundamental design principle of the exemplary device. Furthermore, based on the 200 A breaker TCC shown in FIG. 3C, this fault current magnitude should trip the breaker within 10 seconds. The flux density contour of the transformer core, shown in subpanel (b), demonstrated that the transformer core saturated as the peak flux density achieved is 1.2 T. These results demonstrated that the exemplary device achieved the intended N+1 fault current amplification even though the transformer saturated due to the high-impedance fault scenario. Therefore, this result further validated the IFCM concept and showed the feasibility of minimizing the transformer size by allowing its core to saturate while facilitating the exemplary device to achieve its fundamental OCP goal.

### Discussion

Discussion #1. As the costs associated with distributed energy resources (DERs), such as solar PV, energy storage, and power semiconductors, continue to decline, there is a surge in the penetration of inverter-based resources (IBRs) on the grid [1]. Power systems in parts of Hawaii, Australia, Spain, etc., are already witnessing nearly 100% of the loads in the system being supplied by these IBRs for extended periods [2]. With this increasing IBR penetration in the grids, the grid paradigm is changing as the traditional synchronous generators (SGs) are being replaced by IBRs using power electronics converters for interfacing renewable energy sources to the grid.

These IBRs differ from SGs on several counts. The performance of these IBRs is governed by the programmed control behavior rather than the physics of the system, as is the case for SG-based power systems. The behavior of IBR during faults differs from that of SGs. The overcurrent capacity of IBRs during faults is restricted by the limited overcurrent headroom available with power semiconductor switches [3]. Moreover, the overcurrent behavior also depends on the control that is implemented for IBRs [3]. Unlike these IBRs, SGs can provide current, which is several times their rated value during faults. The relay and circuit breakers in the present grids are tuned according to the high fault currents that the SGs can inject. However, as the IBR penetration increases, the overcurrent seen in the power systems during faults may be significantly lower, potentially leading to uncleared faults.

The compatibility of traditional protection systems for IBR-rich transmission and distribution systems with sophisticated fault-handling algorithms has been analyzed in previous studies [4-7]. As pointed out in previous studies, most cases need an overhaul of either the traditional protection systems or the control structure of inverters to make the IBR-rich grids compatible with the conventional protection systems [4], [6]. However, little attention has been paid to the low-voltage microgrids that are becoming more common worldwide. For example, rooftop solar PV is already reaching nearly 80% of the total generation capacity in some states of Australia [8]. The overcurrent protection in these low-voltage grids comprises an overcurrent relay and a circuit breaker. The overcurrent relay in these low-voltage microgrids may not trip in case of system faults due to a reduced current contribution from these rooftop inverters

In addition to the fault current contribution being too low, fault current may also vary [9]. Depending on the inverter hardware and settings configured by the IBR vendor, the fault currents supplied by different IBRs may vary. To accommodate this variability in fault currents, adaptive protection strategies are being researched for IBR-based grids [10]. Most of these strategies involve sophisticated signal processing algorithms and may be feasible for integrating with relays in transmission/distribution systems. However, applying these algorithms to low-voltage microgrids with overcurrent breakers may be expensive. In addition, the process may be infeasible, considering the number of low-voltage breakers in the system.

Another solution for handling fault currents in IBR-dominant grids involves using solid-state circuit breakers (SSCBs). SSCBs are made of power semiconductor devices as a controllable breaking element and can accommodate intelligent breaking mechanisms, providing a high degree of controllability. However, installing SSCBs would require significant modifications to the existing overcurrent protection (OCP) infrastructure, where all OVP devices in low-voltage systems would need to be replaced with SSCBs. This effort may be economically infeasible to utilities and homeowners [11]. Thus, a low-cost device that is retrofittable and can provide enhanced controllability with the existing protection schemes is needed for such low-voltage microgrids.

The instant study developed a device having an inverter fault current multiplier (IFCM). The exemplary device can amplify the fault current from inverters to trip conventional protection devices in the grid network. To achieve this function, the exemplary device uses a custom power-electronic platform composed of semiconductor switches and a transformer. Furthermore, the integrated sensors and intelligent controller provide a modular solution that can be integrated within or independently of the inverter. The study has so far shown: (i) the challenges that limit the applicability of conventional OCP devices for IBR-grid protection and the limits of prevalent, electronically controllable solutions such as SSCBs, (ii) an IFCM is developed to provide controllable fault current amplification that can achieve the OCP goals of an IBR-rich grid by leveraging existing protection devices, such as breakers and fuses, to prevent the need for resource-intensive infrastructure modification efforts that can be uneconomical to utilities and provides a low-cost pathway to reliably provide OCP in IBR-dominated grid networks, and (iii) hardware validation and design optimization of the exemplary device.

Discussion #2. The exemplary device (having an IFCM) provides a hardware platform to meet the OCP challenges of an IBR-dominated grid network. The exemplary device utilizes a novel combination of AC switches with a transformer to amplify the inverter's fault current contribution in various scenarios, ranging from low to high impedance faults. In addition, the exemplary device treats the inverter as a black box and operates as a modular, plug-and-play solution that can be deployed independently of an inverter or within a new inverter design due to its integrated sensors and microcontroller. This feature of the exemplary device may prevent modifying the existing OCP device infrastructure, otherwise resulting in an uneconomical task for utility operators when considering existing electronically controllable alternatives. Simulation and experimental results in the study validated the operating principle of the exemplary device. In addition, the integrated transformer is optimized by allowing its magnetic core to saturate without compromising the exemplary device's performance to achieve the necessary fault current amplification that can trip a 200 A main breaker in an LV residential setting.

The experimental results in the study validated the switching method of the exemplary device to achieve the necessary current multiplication. An optimization method was also developed to minimize the size of the IFCM transformer by allowing the transformer's core to saturate while still attaining the current multiplication effect. The final optimized design resulted in a 92% reduction in the transformer's rated voltage, and FEA simulation results showed the preliminary feasibility of this minimized transformer design. Finally, the observed voltage and current waveforms showed that this equivalent transformer did not saturate, which indicated that the transformer size can be further reduced to minimize the size and cost of the exemplary device.

The exemplary device can also meet the overcurrent protection needs of IBR-dominant grid systems beyond the residential use case defined in the study, where the system scale can be larger than that of a typical residential setting. On a distribution grid level, overcurrent relays are used for OCP. As discussed above, inverters' limited and variable fault current contribution may require updating the relay devices to reliably protect the IBR-rich system. This process of updating or modifying the existing relay infrastructure can be an expensive task that can be infeasible for utilities and system operators. However, the exemplary device can multiply the fault current contribution from inverters and facilitate the selective tripping of existing relay-based OCP devices. Through this mechanism, the exemplary device can eliminate the need for any modifications of the OCP infrastructure in an IBR-dominant grid system while maintaining the proper protection zone coordination between different relays in an IBR-rich grid.

In some embodiments, the transformer may be minimized (for cost and/or size) for the transformer core saturation.

The exemplary device may unlock a pathway for enhancing an inverter's response in fault scenarios to improve the overall stability of a high-IBR penetrated grid network.

In some embodiments, an intelligent fault detection algorithm may be implemented in to provide control of the exemplary device by facilitating the accurate detection and classification of various operating modes, ranging from high or low fault current scenarios.

### CONCLUSION

The construction and arrangement of the systems and methods, as shown in the various implementations, are illustrative only. Although only a few implementations have been described in detail in this disclosure, many modifications are possible (e.g., variations in sizes, dimensions, structures, shapes, proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative implementations. Other substitutions, modifications, changes, and omissions may be made in the design, operating conditions, and arrangement of the implementations without departing from the scope of the present disclosure.

The present disclosure contemplates methods, systems, and program products on any machine-readable media for accomplishing various operations. The implementations of the present disclosure may be implemented using existing computer processors, or by a special purpose computer processor for an appropriate system, incorporated for this or another purpose, or by a hardwired system. Implementations within the scope of the present disclosure include program products, including machine-readable media for carrying or having machine-executable instructions or data structures stored thereon. Such machine-readable media can be any available media that can be accessed by a general-purpose or special-purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor.

When information is transferred or provided over a network or another communications connection (either hardwired, wireless, or a combination of hardwired or wireless) to a machine, the machine properly views the connection as a machine-readable medium; thus, any such connection is properly termed a machine-readable medium. Combinations of the above are also included within the scope of machine-readable media. Machine-executable instructions include, for example, instructions and data that cause a general-purpose computer, special-purpose computer, or special-purpose processing machine to perform a certain function or group of functions.

Although the figures show a specific order of method steps, the order of the steps may differ from what is depicted. Also, two or more steps may be performed concurrently or with partial concurrence. Such variation will depend on the software and hardware systems chosen and on the designer's choice. All such variations are within the scope of the disclosure. Likewise, software implementations could be accomplished with programming techniques with rule-based logic and other logic to accomplish the various connection steps, processing steps, comparison steps, and decision steps.

It is to be understood that the methods and systems are not limited to specific synthetic methods, specific components, or to particular compositions. It is also to be understood that the terminology used herein is for the purpose of describing particular implementations only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense but for explanatory purposes.

Disclosed are components that can be used to perform the disclosed methods and systems. These and other components are disclosed herein, and it is understood that when combinations, subsets, interactions, groups, etc. of these components are disclosed while specific reference of each various individual and collective combinations and permutation of these may not be explicitly disclosed, each is specifically contemplated and described herein, for all methods and systems. This applies to all aspects of this application, including, but not limited to, steps in disclosed methods. Thus, if there are a variety of additional steps that can be performed it is understood that each of these additional steps can be performed with any specific implementation or combination of implementations of the disclosed methods.

The following patents, applications, and publications, as listed below and throughout this document, are hereby incorporated by reference in their entirety herein.
[1] J. Benzaquen, M. Miranbeigi, P. Kandula, and D. Divan, “Collaborative autonomous grid-connected inverters: Flexible grid-forming inverter control for the future grid,” IEEE Electrification Magazine, vol. 10, no. 1, pp. 22-29, 2022.
[2] A. Hoke, V. Gevorgian, S. Shah, P. Koralewicz, R. W. Kenyon, and B. Kroposki, “Island power systems with high levels of inverter-based resources: Stability and reliability challenges,” IEEE Electrification Magazine, vol. 9, no. 1, pp. 74-91, 2021.
[3] N. Baeckeland, D. Chatterjee, M. Lu, B. Johnson, and G.-S. Seo, “Overcurrent limiting in grid-forming inverters: A comprehensive review and discussion,” IEEE Transactions on Power Electronics, vol. 39, no. 11, pp. 14 493-14 517, 2024.
[4] A. Hooshyar, M. A. Azzouz, and E. F. El-Saadany, “Distance protection of lines emanating from full-scale converter-interfaced renewable energy power plants-part i: Problem statement,” IEEE Transactions on Power Delivery, vol. 30, no. 4, pp. 1770-1780, 2015.
[5] N. Baeckeland, D. Venkatramanan, S. Dhople, and M. Kleemann, “On the distance protection of power grids dominated by grid-forming invert-ers,” in 2022 IEEE PES Innovative Smart Grid Technologies Conference Europe (ISGT-Europe), 2022, pp. 1-6.
[6] M. A. Haj-ahmed and M. S. Illindala, “The influence of inverter-based dgs and their controllers on distribution network protection,” IEEE Transactions on Industry Applications, vol. 50, no. 4, pp. 2928-2937, 2014.
[7] P. T. Mana, M. Miranbeigi, J. Benzaquen, and D. M. Divan, “Fault characterization of an unbalanced islanded microgrid,” in 2022 IEEE Power Energy Society General Meeting (PESGM), 2022, pp. 1-5.
[8] “Open electricity,” accessed: 2024 Nov. 6. [Online]. Available: https://explore.openelectricity.org.au
[9] F. Blaabjerg, Y. Yang, D. Yang, and X. Wang, “Distributed power-generation systems and protection,” Proceedings of the IEEE, vol. 105, no. 7, pp. 1311-1331, 2017.
[10] S.-C. Hsieh, C.-S. Chen, C.-T. Tsai, C.-T. Hsu, and C.-H. Lin, “Adaptive relay setting for distribution systems considering operation scenarios of wind generators,” IEEE Transactions on Industry Applications, vol. 50, no. 2, pp. 1356-1363, 2014.
[11] S. Weintraub, “Span smart panel expands home-builder/utility footprint with additional form factors,” Electrek, Mar, vol. 11, 2024, accessed May 26, 2024). [Online]. Available: https://electrek.co/2024/03/11/span-smart-panel-expands-homebuilder-utility-footprint-with-additional-form-factors/
[12] D. Vigstol, “Understanding our electrical world: 8 items that form the grounding electrode system,” Www.nfpa.org, 2021, accessed 1 Jul. 2024.
[13] Panelboard and switchboard series rating information manual, Eaton, April 2020, information Manual 1C96944H02.
[14] P. M. Gajare, M. Miranbeigi, J. Benzaquen, and D. Divan, “On the fault-ride-through dynamics of grid-forming converters—a multi-dimensional adaptive inertia approach,” in Proc. IEEE Appl. Power Electron. Conf. Expo., Orlando, USA, 2023.
[15] DET1048 TMQC, TMQF, TMQV Time Current Curves, ABB, March 2018, series C F-Frame Time Current Curves.
[16] S. Havanur, Power MOSFET Basics—Understanding Voltage Ratings, Vishay Siliconix, 1 2017, application Note—AN851.
[17] Triggering and Gate Characteristics of Thyristors, Littelfuse, thyristor Design Guide.
[18] N. Mohan, T. M. Undeland, and W. P. Robbins, Power Electronics Converters, Applications, and Design. Wiley, 2018, ch. Thyristors.
[19] Voltage Source Inverter Reference Design, Texas Instruments, 2020, rev. E.
[20] W. Du, Q. Nguyen, Y. Liu, and S. M. Mohiuddin, “A current limiting control strategy for single-loop droop-controlled grid-forming inverters under balanced and unbalanced faults,” in 2022 IEEE Energy Conversion Congress and Exposition (ECCE), 2022, pp. 1-7.
[21] J11F3 Datasheet, CIT Relay and Switch, 2023.
[22] N. Mohan, T. M. Undeland, and W. P. Robbins, Power Electronics Converters, Applications, and Design. Wiley, 2018, ch. Design of Magnetic Components.
[23] M. Tonso, J. Moren, S. de Haan, and J. Ferreira, “Variable inductor for voltage control in distribution networks,” in 2005 European Conference on Power Electronics and Applications, 2005, pp. 10 pp.-P.10.
[24] National Fire Protection Association, National Electrical Code. Quincy, MA: NFPA, 2023.
[25] “The classical approach.”
[26] Finemet Nanocrystalline Cores, Hitachi Metals Ltd., 2014, Datasheet.

What is claimed is:

1. A device configured to couple between an inverter and a circuit breaker to facilitate tripping of the circuit breaker, the device comprising:
a fault current multiplier circuit comprising:
a transformer having a primary winding and a secondary winding, wherein the secondary winding is operatively connected with the primary winding and the circuit breaker;
a first switch coupled in series with the secondary winding;
a second switch configured to be in conductive mode and non-conductive mode, the second switch being connected in parallel to the primary winding to bypass the transformer when the second switch is in conductive mode and to urge current flow through the transformer when in non-conductive mode;
a sensor disposed in the fault current multiplier circuit and configured to measure an inverter current, or a proportional aspect thereof, provided by the inverter to the circuit breaker;
a controller operatively coupled to the first switch and the second switch, the controller being configured to:
receive or measure, via the sensor, the inverter current, or a proportional aspect thereof; and
in response to the inverter current, or the proportional aspect thereof, meeting a fault condition for the circuit breaker, cause the first switch to switch to the conductive mode and the second switch to switch to the non-conductive mode, to allow current to flow through the primary winding and the secondary winding, thereby generating a multiplied inverter current of sufficient magnitude to the circuit breaker to trip mechanical circuit elements of the circuit breaker.

2. The method of claim 1, wherein the transformer is fully rated or fractionally rated.

3. The method of claim 1, wherein the primary winding has a higher voltage rate than the secondary winding.

4. The method of claim 1, wherein the primary winding has a lower voltage rate than the secondary winding.

5. The device of claim 1, wherein the controller is configured via instructions to cause the second switch to switch to the non-conductive mode after the controller causes the first switch to switch to the conductive mode.

6. The device of claim 5, wherein the generated multiplied inverter current has a magnitude corresponding to a predefined saturation current and a predefined turns ratio of the transformer to trip the breaker that is downstream of the inverter.

7. The device of claim 6, wherein in response to the mechanical circuit elements of the circuit breaker being tripped, the controller is configured to:
cause the first switch to switch to the non-conductive mode and the second switch to switch to the conductive mode.

8. The device of claim 7, wherein the controller is integrated into the device.

9. The device of claim 7, wherein the controller is an external controller coupled between an inverter and a circuit breaker.

10. The device of claim 1 is part of a system comprising:
one or more power sources connected to a grid, wherein the one or more power sources are configured to power downstream loads when islanded from the grid, wherein the loads are connected via either a cascaded switchgear or a fuse configured to trip on the multiplied inverter current, and wherein the one or more power sources are a power electronics inverter configured to supply power to the grid or to power the load when the grid is not connected or available.

11. The device of claim 1, wherein the inverter is configured to limit current under the fault condition to at least one of (i) a value higher than a maximum sustained current it can deliver or (ii) a value that is unable to trip the breaker, as the current under the fault condition is lower than available in grid-connected mode.

12. The device of claim 11, wherein the first switch is a bidirectional current block switch when in the non-conductive mode and is selected from the group consisting of (i) one or more mechanical power relays and (ii) one or more semiconductor switches.

13. The device of claim 12, wherein the second switch is a low loss current carrying component when in the conductive mode and is selected from the group consisting of (i) one or more mechanical power relays and (ii) one or more semiconductor switches.

14. A method comprising:
providing a device comprising:
a fault current multiplier circuit comprising:
a transformer having a primary winding and a secondary winding, wherein the secondary winding is operatively connected with the primary winding and a circuit breaker;
a first switch coupled in series with the secondary winding to magnetize the transformer when in conductive mode;
a second switch configured to be in conductive mode and non-conductive mode, the second switch being connected in parallel to the primary winding to bypass the transformer when the second switch is in conductive mode and to urge current flow through the transformer when in non-conductive mode;
a sensor disposed in the fault current multiplier circuit and configured to measure an inverter current, or a proportional aspect thereof, provided by the inverter to the circuit breaker;
a controller operatively coupled to the first switch and the second switch, the controller being configured to:
receiving or measuring, via a sensor, an inverter current, or a proportional aspect thereof; and
in response to the inverter current, or the proportional aspect thereof, meeting a fault condition for the circuit breaker, causing the first switch to switch to a conductive mode and the second switch to switch to a non-conductive mode, to allow current to flow through a primary winding and a secondary winding of the transformer, thereby generating a multiplied inverter current of sufficient magnitude to the circuit breaker to trip mechanical circuit elements of the circuit breaker.

15. The method of claim 14, wherein the second switch is switched to the non-conductive mode after the first switch is switched to the conductive mode.

16. The method of claim 15, wherein the generated multiplied inverter current has a magnitude corresponding to a predefined saturation current and a predefined turns ratio of the transformer.

17. The method of claim 16 further comprising:
in response to the mechanical circuit elements of the circuit breaker being tripped, switching the first switch to the non-conductive mode and the second switch to the conductive mode.

18. The method of claim 17, wherein the device is a part of a system comprising:
one or more power sources connected to a grid, wherein the one or more power sources are configured to power downstream loads when islanded from the grid, wherein the loads are connected via either a cascaded switchgear or a fuse configured to trip on the multiplied inverter current, and wherein the one or more power sources are a power electronics inverter configured to supply power to the grid or to power the load when the grid is not connected or available.

19. The method of claim 17, wherein the inverter is configured to limit current under the fault condition to at least one of (i) a value higher than a maximum sustained current it can deliver or (ii) a value that is unable to trip the breaker, as the current under the fault condition is lower than available in grid-connected mode.

20. A method of installation comprising:
providing a device comprising:
a fault current multiplier circuit comprising:
a transformer having a primary winding and a secondary winding, wherein the secondary winding is operatively connected with the primary winding and a circuit breaker;
a first switch coupled in series with the secondary winding to magnetize the transformer when in conductive mode;
a second switch configured to be in conductive mode and non-conductive mode, the second switch being connected in parallel to the primary winding to bypass the transformer when the second switch is in conductive mode and to urge current flow through the transformer when in non-conductive mode;
a sensor disposed in the fault current multiplier circuit and configured to measure an inverter current, or a proportional aspect thereof, provided by the inverter to the circuit breaker;
a controller operatively coupled to the first switch and the second switch, the controller being configured to:
receive or measure, via the sensor, the inverter current, or a proportional aspect thereof; and
in response to the inverter current, or the proportional aspect thereof, meeting a fault condition for the circuit breaker, cause the first switch to switch to the conductive mode and the second switch to switch to the non-conductive mode, to allow current to flow through the primary winding and the secondary winding, thereby generating a multiplied inverter current of sufficient magnitude to the circuit breaker to trip mechanical circuit elements of the circuit breaker;
mounting the device;
cutting the cable between the inverter and the circuit breaker into a first cable and a second cable;
terminating the first cable and the second cable at each respective end;
connecting the first cable to a first terminal of the device to establish electrical connection between the primary winding of the fault current multiplier circuit and a terminal of the inverter; and
connecting the second cable to a second terminal of the device to establish electrical connection between the secondary winding of the fault current multiplier circuit to a terminal of the circuit breaker.
